(19) United States
(12) Patent Application Publication
(10) Pub. No.: US 2024/0278278 A1
(43) Pub. Date: Aug. 22, 2024

(54) CONTAINER LID FOR A CONTAINER, AND METHOD AND APPARATUS FOR FILLING A CONTAINER

(71) Applicant: System Biologie Deutschland UG (haftungsbeschränkt), Gablingen (DE)

(72) Inventors: Tom PHILIPPS, Mühltal (DE); Robert TOROCZKAY, Hirschberg (DE)

(73) Assignee: System Biologie Deutschland UG (haftungsbeschränkt), Gablingen (DE)

(21) Appl. No.: 18/569,782

(22) PCT Filed: Jun. 14, 2022
(86) PCT No.: PCT/EP2022/066173

§ 371 Date: Dec. 13, 2023

(30) Foreign Application Priority Data
Jun. 14, 2021 (EP) 21179368.2

(51) Int. Cl. B05B 15/25; B01F 27/1123; B01F 33/00; B05B 11/00; B05B 11/10

(52) U.S. Cl. CPC B05B 15/25; B01F 27/1123; B01F 33/86; B05B 11/0097; B05B 11/1047

(57) ABSTRACT

A container lid for a container for holding liquid or paste-like products has a lid body, which can be fixed to a container housing of the container via a container opening. By a manually operable metering dispenser device a predefinable quantity of the product can be dispensed from the container housing through a product dispensing opening of the metering dispenser device when an actuating element of the metering dispenser device is actuated. A mixing device for the product located in the container has a displaceable mixing element, which is operatively connected to the actuating element of the metering dispenser device and which is displaced by an actuation of the actuating element. In a filling process, the container is filled with several product components and mixed in a mixing step with the aid of the mixing device located on the container lid before the container is sealed with the container lid.

### CROSS-REFERENCE TO RELATED APPLICATION

This application is a national stage application, filed under 35 U.S.C. § 371, of International Patent Application PCT/EP2022/066173, filed on Jun. 14, 2022, which claims the benefit of European Patent Application EP 21179368.2, filed on Jun. 14, 2021.

### BACKGROUND

The disclosure relates to a container lid for a container for holding liquid or paste-like products, said container lid having a lid body, which can be fixed to a container housing of the container via a container opening, and has a manually operable metering dispenser device, by means of which a predefinable quantity of the product can be dispensed from the container housing through a product dispensing opening of the metering dispenser device when an actuating element of the metering dispenser device is actuated.

Such container lids with a manually operated metering dispenser device are known in various designs and are suitable for the metered dispensing of a liquid or paste-like product from a container. Such metering dispenser devices can be used, for example, in soap dispensers in which an actuating element is pressed or displaced and a predetermined amount of soap is conveyed out of the container and dispensed through a product dispensing opening. The product dispensing opening is often arranged at one end of the actuating element, wherein a product dispensing channel connects an interior of the container with the product dispensing opening in the actuating element.

Starting from the product dispensing opening, the product dispensing channel opens into a metering dispenser chamber of the metering dispenser device, which is arranged in the interior of the container. The metering dispenser chamber has at least one chamber opening through which the product in the interior of the container can flow into the metering dispenser chamber. When the actuating element is actuated, the chamber opening is closed. At the same time, a displacement element of the metering dispenser device penetrates into the metering dispenser chamber and displaces a portion of a product quantity located in the metering dispenser chamber, which is pressed through the product dispensing channel and dispensed through the product dispensing opening. As soon as the actuating element is released and no longer actuated, the actuating element is displaced back into an unactuated initial state by a spring device. The product dispensing channel is closed, the chamber opening of the metering dispenser chamber is opened and the displacement element is moved out of the metering dispenser chamber so that the product quantity dispensed during actuation can flow from the interior of the container into the metering dispenser chamber and the metering dispenser device is ready for actuation again and the resulting further dispensing of a product quantity from the container.

Such metering dispenser devices are widely used in practice and are suitable for numerous different areas of application and for the metered dispensing of different products. The products can be liquid or paste-like, wherein liquid refers to a viscosity of the product that is comparable to the viscosity of water, and paste-like refers to a higher viscosity than the viscosity of water and a paste-like product is therefore more viscous or less flowable than water.

A metering dispenser device can be inexpensively manufactured and assembled from just a few individual parts. Many metering dispenser devices can be used reliably and without maintenance over a long period of time. Most metering dispenser devices are resistant to the mechanical stresses that usually occur. Due to the design and dimensions of the metering dispenser chamber in particular, different quantities of the product can be dispensed by a single actuation. The metering dispenser device can therefore be easily adapted to different products and containers or container sizes.

The metering dispenser devices known in practice have a metering dispenser chamber with a chamber opening, the arrangement of which does not change relative to the container lid and thus to the surrounding container during the service life of the container. The chamber opening can therefore be arranged in an area within the interior of the container that is located at the bottom when the container is used as intended, so that the amount of product in the interior of the container also accumulates in the area of the chamber opening as the container is increasingly emptied and the container can be emptied largely or almost completely with the metering dispenser device. In many cases, the metering dispenser chamber and therefore also the chamber opening is located in the area of the container lid or close to it. The chamber opening is then often connected to a suction pipe, which usually extends to the bottom of the container or at least close to the bottom of the container, in order to be able to reach into the product residues accumulating at the bottom as the container is emptied and to suck a quantity of product into the metering dispenser chamber when the actuating element is actuated.

Products are known that consist of two or more product components. With some products, segregation and separation of the various product components does not occur or only occurs so slowly that during a normal service life of a container filled with the mixed product, no significant separation occurs and thus no significant inhomogeneity of the product occurs over a long service life during a product dispensing effected by the metering dispenser device. In contrast, other products can be composed of two or more product components that separate after a comparatively short period of time, whereby after some time the dispensing of the product with the metering dispenser device is impaired and the desired homogeneously mixed product is no longer dispensed, but predominantly a separated product component.

In the case of comparatively low-viscosity products, the product components can be mixed and homogenised again, for example by briefly shaking the container before actuating the actuating element and dispensing the product with the metering dispenser device. In particular with paste-like and very viscous products, remixing the individual product components by suitably shaking or moving the container is comparatively time-consuming and often does not lead to the desired or sufficient mixing and subsequent dispensing of a sufficiently homogeneous product, even with a longer shaking time.

### SUMMARY

The present disclosure provides a container lid with a metering dispenser device in such a way that when the metering dispenser device is actuated, the product dispensed is as homogeneous as possible.

This is achieved in that, when the container lid is used as intended, the container lid engages with the container with a mixing device for the product located in the container, wherein the mixing device has a displaceable mixing element that is operatively connected to the actuating element of the metering dispenser device and is displaced by actuation of the actuating element. Preferably, the mixing device is arranged on the container lid.

When the container lid is used as intended, the mixing device is located in the interior of the container. Intended use comprises not only closing the container with the container lid, but also a mixing process carried out with the mixing device, with which the product in the container is mixed without the container lid having to be fixed on the container.

The displacement of the mixing element forces a corresponding displacement and circulation of the product in the interior of the container, thereby causing the product to mix. The active connection between the displaceable mixing element and the actuating element, which is also displaceably mounted, ensures that every time the actuating element is actuated, which causes a small amount of product to be dispensed from the container, the amount of product inside the container is mixed at the same time. This results in a high level of operating convenience, as no separate mixing of the product is required, for example before product removal. In contrast to separate mixing, which must be effected, for example, by shaking the container before the product is removed, mixing of the product cannot be forgotten when the container lid is designed as disclosed herein. Each product dispensed by the metering dispenser device simultaneously causes the product in the container to be mixed again.

The active connection between the actuating element and the displaceable mixing element can be designed in such a way that the product in the container is already sufficiently mixed when the actuating element is actuated once and the amount of product dispensed from the container by the metering dispenser device is sufficiently homogenised for the intended use of the product.

The way in which the mixing element is displaced can correspond to the displacement of the actuating element, so that a rigid connection between the actuating element and the mixing element is possible. For example, the mixing element can be fixed protruding laterally on a rod that is rigidly connected to the actuating element and aligned in such a way that the rod with the mixing element protrudes from the container lid into the interior of the container. It is also conceivable that the mixing element is rotatably mounted about an axis of rotation and that a displacement of the actuating element along the axis of rotation is converted into a rotary movement of the mixing element about the axis of rotation.

The mixing element can be tongue-shaped or paddle-shaped, for example. The mixing element can be essentially flat or have a complex three-dimensional shape. The mixing element is displaced along a predetermined mixing element trajectory within the interior of the container by actuating the actuating element of the metering dispenser device and displaces a portion of the product located in the area of this mixing element trajectory, thereby causing the product to be mixed in the interior of the container. The shape of the mixing element is predetermined so that the movement of the mixing element within the container causes the product in the container to be mixed as efficiently as possible.

The mixing device can also have a plurality of mixing elements, which can be displaced uniformly or relative to each other by actuating the actuating element. A mixing element can also be operatively connected to the actuating element via a gear, so that a displacement of the actuating element along an actuating element trajectory causes a displacement of the mixing element along a mixing element trajectory that is shorter or preferably significantly longer than the actuating element trajectory.

For many applications, it is advantageous if the mixing device is arranged or mounted on the container lid and can be moved together with the container lid. In order to carry out a mixing process, the container lid can be brought close to the container and then moved so that a mixing element of the mixing device protrudes into the interior of the container and is displaced in the interior by the movement of the container lid in order to mix the product inside. It is also conceivable that the mixing device is arranged in the container and that the container lid can be brought up to the container in such a way that the actuating element of the metering dispenser device is brought into operative connection with the mixing device located in the interior of the container.

One embodiment consequently provides that the metering dispenser device has an intake pipe extending away from the lid body for the product to be dispensed through the product dispensing opening, and in that the mixing element is displaceably mounted on an end region of the intake pipe remote from the cover body. In order to be able to empty the interior of the container as completely as possible with the metering dispenser device arranged on the container lid, an intake pipe extending away from the lid body is advantageous, which protrudes far into the interior of the container and, if necessary, extends to the bottom of the container. An intake opening for the product to be dispensed with the metering dispenser device can expediently be formed on the end face at an open end of the intake tube or laterally in an end region of the intake tube remote from the lid body. Advantageously, it is provided that the mixing element is arranged at the end region of the intake pipe remote from the lid body and can be displaced there in order to be able to reliably mix the remaining residual amount of product even as the container is increasingly emptied. The arrangement and design of the mixing element, which is displaceably mounted on the end region of the suction tube, can be predetermined in such a way that mixing of the product takes place in particular in an area around the suction opening, so that a quantity of product mixed during actuation of the actuating element is sucked through the intake tube into the metering dispenser chamber and conveyed.

In an advantageous manner, it is optionally provided that the mixing element extends in the longitudinal direction of the intake pipe beyond an intake opening formed in the intake pipe for the product to be dispensed. In this way, it can be achieved that, in particular, an area surrounding the intake opening is effectively mixed when the mixing element is actuated and, in particular, an intake area around the intake tube contains a well-mixed product. It may also be provided that a plurality of mixing elements is formed along the suction tube, which mixing elements are displaced by actuation of the actuating element of the metering dispenser device, thereby causing the product to be mixed throughout the interior of the container.

According to a particularly advantageous embodiment, it is provided that the mixing device has a displaceably mounted mixing element sleeve, which is arranged coaxially to the intake pipe and is operatively connected to the actuating element, so that the mixing element sleeve is displaced relative to the intake pipe when the actuating element is actuated. The mixing element sleeve can be moved back and forth in an axial direction and thus along a direction specified by the intake pipe. It is also conceivable and advantageous for many containers or for many products that the mixing element sleeve is set in a rotational movement by actuating the actuating element and is rotated relative to the suction pipe. A suitable transmission ratio or a mechanical transmission device can be used to achieve a short displacement of the actuating element in a rotary movement of the mixing element sleeve and thus of the mixing elements arranged thereon, which may comprise several complete revolutions. It is also conceivable that the mixing element sleeve performs both an axial displacement and a rotational movement during complete actuation of the actuating element. The displacement of the mixing element sleeve can take place simultaneously along an axial direction and in the circumferential direction, or individual displacement sections can be specified in which an axial displacement or a rotational movement of the mixing element sleeve takes place predominantly or exclusively.

A single mixing element can be rigidly fixed to the mixing element sleeve. It is also conceivable that the mixing element is connected to the mixing element sleeve via an articulated manner or via an active connection and is caused to move in a different direction within the interior of the container by a displacement of the mixing element sleeve. A plurality of mixing elements can also be arranged or formed on the mixing element sleeve.

For many liquid and paste-like products, it is considered advantageous that the mixing element is pivotably mounted about a displacement axis extending away from the cover body. It has been shown that a comparatively effective mixing of the product in the environment around the mixing element can be achieved by moving the mixing element in the circumferential direction. It is also conceivable and advantageous for corresponding applications that the mixing element can be moved along a helical line within the container. In this way, a volume extending along the displacement axis in the axial direction within the interior of the container can be traversed by the mixing element and the product located in this area can be mixed as a result.

According to one embodiment that is considered particularly advantageous, it is provided that the mixing element has at least one mixing blade extending along a helical line. A mixing blade shaped in this way forms a mixing element that causes adjacent product quantities to be displaced both in the circumferential direction and simultaneously in the axial direction within the interior of the container, even if the displacement takes place exclusively in the axial direction or exclusively in the circumferential direction. In this way, particularly efficient mixing of the product in the container can be achieved without the need for a structurally elaborate and complex active connection between the usually linearly displaceable actuating element on the one hand and the mixing element on the other. The mixing blade running along a helix can only extend over part of the circumference in the circumferential direction. It is also possible for the mixing blade to extend in the circumferential direction over a complete circumference or to be longer in the circumferential direction than a complete circumference of the container.

The mixing blade can have a flat surface and extend radially from a displacement axis to an outer circumferential edge of the mixing blade. It is optionally provided and advantageous with regard to the most efficient mixing of the product in the interior that the at least one mixing blade is mounted at a radial distance from a displacement axis. Such a mixing blade is therefore essentially band-shaped and runs along a helix with a radial distance around a displacement axis. The displacement of such a band-shaped mixing blade can take place along an axial direction of the displacement axis or in a circumferential direction about the displacement axis. The mixing blade can be flat or straight in the radial direction. It is also conceivable that the mixing blade has a curvature in the radial direction. Curved or angled edge areas of the mixing blade can also be provided.

Instead of a helical mixing blade, a mixing element or several mixing elements can also be provided, which are designed with a flat surface and protrude in the form of a tongue or paddle from a mixing element fastening that expediently runs along a displacement axis. Each individual mixing element can also have a complex shape and, for example, have a curvature or bevelled edge or projecting formations that may protrude from the mixing element in different directions. A mixing element can also have a convex or concave curvature.

Advantageously, the mixing element is made of a material or has a coating with a material that has the least possible adhesive effect for the product filled into the container. This prevents product residues from adhering to the mixing element in the areas of the interior of the container that are no longer completely filled with the product as the container is emptied and prevent drying out over time. In particular, when using several mixing elements, each with a complex shape, a noticeable proportion of the product could adhere and dry out in this way and is then no longer available to be dispensed by the metering dispenser device. It would then also be virtually impossible to prevent dried or dried-out product residues from being detached from the mixing element during a new mixing process and then being dispensed from the container using the metering dispenser device. By designing the mixing element with the lowest possible adhesion effect for the product, such detrimental effects during the gradual emptying of the container can be avoided.

If necessary, it may be advisable to cover an intake opening for transferring the product from the interior of the container into the metering dispenser chamber with a close-meshed grid or net or with a membrane that is permeable to the product, in order to prevent larger particles from entering the metering dispenser chamber through the intake opening and being dispensed when the actuating element is actuated.

The disclosure also relates to a method for filling a container with a liquid or paste-like product, wherein the product is introduced into the container through a container opening in a filling step with a filling device and the filled container is then closed with a container lid.

Numerous methods are known in practice that can be used to fill a container with a liquid or paste-like product in a partially or fully automated process. In many cases, the container is placed under a filling device with a filling nozzle and the liquid or paste-like product is filled into the container from the filling nozzle. The filling nozzle can either be arranged directly above the container opening or protrude slightly through the container opening into the interior of the container in order to prevent a proportion of the product quantity from flowing sideways past the container opening during the filling process or sticking to a container rim surrounding the container opening.

After the container has been filled with the predetermined quantity of product, a container lid is usually fixed to the container using a container lid handling device, thereby closing the container opening used for filling the container.

The container opening used for filling can then also be used to remove the product from the filled container. For this purpose, the container lid can be screwed onto a screw thread formed on the container, for example, and unscrewed if necessary in order to remove a quantity of the product in the container through the container opening, which is then open. With other container lids, a sealing cap can be opened or pulled off to reveal a removal opening in the container lid. Container lids are also known that have a metering dispenser device that can be used to dispense a predetermined quantity of product by actuating the metering dispenser device.

For some products, it is necessary to mix the product filled into the container before sealing. In particular, mixing can be advantageous or even necessary if the product is composed of several product components that are filled into the container one after the other. To mix the product, the container can be closed with the container lid and then moved along a predetermined mixing trajectory to mix the product in the container. It is also known that instead of this or in addition a mixing device is introduced into the interior of the filled container and the product inside is mixed with the mixing device. The mixing device is removed from the container after the mixing process and the container is closed with the container lid.

Such a method, which is already known in practice, can be carried out cost-effectively and completely automatically, in particular if a large number of similar containers are to be filled with the same product. The mixing device removed from an already mixed container can then be introduced directly into the next container and used to mix the same product in this next container. However, such a method is often associated with considerable effort and corresponding costs if different products are to be filled into containers that are to be mixed in succession. In this case, it is often necessary for the mixing device to be cleaned between two successive mixing processes in order to prevent a proportion of a product from a first and already mixed container, which remains adhered to the mixing device after the mixing process in the first container, from subsequently being introduced into a second container that is still to be mixed. For small quantities of individual product components in particular, which may also be cost-intensive, the proportion of individual product components that adhere to and have to be removed from the mixing device as a result of such cleaning processes and therefore cannot be filled into the containers can be high compared to the total quantity of product components filled and drive up the filling costs even further.

It is therefore regarded as an object of the present disclosure to design a method already known in practice for filling a container in such a way that successive filling operations can be carried out as efficiently and cost-effectively as possible, in which different products are filled in successive filling operations.

This object is achieved in that the product filled into the container is mixed in a mixing step, wherein the container lid is brought into operative connection with a mixing device in an interior of the container or the container lid has a mixing device with a mixing element that is introduced into an interior of the container during the mixing step, and in that a mixing element of the mixing device is displaced in the interior of the container before the container lid is fixed on the container and the container opening is thereby closed. Either the mixing device, which is used to mix the product in the container, is already in the container or it is arranged or formed on the container lid, which is then fixed to the container in question and thereby closes the container opening. In both cases, only the mixing device associated with the relevant container is used for a mixing process in a container. Subsequent cleaning of the mixing device is not necessary, as the mixing device remains on the container or in the interior of the container. After filling, the container can be removed from the filling device and returned to its intended use.

Since the mixing device remains in the interior of the container after the mixing step has been carried out, it can be ruled out that any quantity of product adhering to the mixing device is discharged from the container during a filling process and lost when it comes to filling the container. In particular, when filling a small container with a small volume of a valuable product or a product made up of valuable product components, the amount of product lost during the filling process can be reduced as far as possible, making the filling process very cost-effective and efficient. The product quantities adhering to the mixing device could lead to contamination of the mixing device and the filling device used for the filling process after it has been removed from the container, meaning that time-consuming cleaning would be necessary.

Since the mixing device is attached to or formed on the container lid and no separate handling of the mixing device on the one hand and the container lid during subsequent closing of the container on the other is required during the filling process, the filling process can be carried out and completed very quickly. In addition, fewer components are required for an apparatus with which the filling process can be automated.

In order to mix the product in the interior of the container as quickly and efficiently as possible, the container lid with the mixing device projecting into the interior of the container can optionally be rotated about an axis of rotation during the mixing step. The axis of rotation expediently corresponds to a centre axis of the container running through the container opening. In the case of a container with an essentially rotationally symmetrical shape, the axis of rotation of the mixing device can correspond to the axis of rotation of the container shape. It is also possible, for example, that the container opening is not centred or that the container lid is arranged on the container opening in such a way that the axis of rotation of the mixing device does not run symmetrically within the surrounding container.

It is also conceivable that the mixing device projecting into the interior of the container is not rotated around a pivot axis, but merely performs several successive pivoting movements about a pivot axis. Furthermore, the mixing device can also be displaced linearly along a displacement axis and thus moved back and forth several times during actuation of the actuating device, for example.

It is provided that the mixing device is displaced in the interior of the container filled with the product during the mixing step for the purpose of mixing in a manner that does not correspond to closing the container with the container lid. If the mixing device is arranged on the container lid, the container lid can be displaced back and forth several times along a displacement axis at a distance from the container opening during the mixing step, for example, or can be rotated or wobbled about an axis of rotation at a distance from the container opening in order to mix the product already filled into the container with the mixing device projecting into the interior of the container without simultaneously fixing the container lid on the container.

Advantageously, it can optionally be provided that, in the mixing step, a container lid is used with a mixing device and with a metering dispenser device, with which a predefinable quantity of the product can be dispensed from the container housing through a product dispensing opening of the metering dispenser device when an actuating element of the metering dispenser device is actuated. In particular, it is preferable to use a container lid as described above. This has the advantage that the container lid does not have to be removed from the container to remove the product after the filling process and the mixing device, which is used to mix the product in the interior of the container during the mixing step, no longer has to be removed from the container. This also prevents product quantities adhering to the mixing device from being removed from the container together with the mixing device after mixing and filling, which reduces the amount of product remaining in the container. Since the container lid not only has a mixing device, but also a metering dispenser device, the product can be removed from the interior of the container via the metering dispenser device after filling in the apparatus without having to detach the container lid from the container and open the container opening closed by the container lid. This also means that the product in the container is better protected against environmental influences and unintentional contamination and that the maximum service life until the container is completely emptied can be specified for longer. When using a container lid with a mixing device, which is also actuated when the metering dispenser device is actuated, the product in the interior is also mixed with the same mixing device that was used in the mixing step during the filling process each time the filled container is removed.

The method for filling a container is optionally suitable, in particular, for carrying out at least two product component filling steps one after the other in the filling step, in each of which one product component is filled into the container. The at least two product components can be paste-like materials, for example, which would not mix or would only mix insufficiently without subsequent mixing. A mixing step then ensures that the two product components mix sufficiently and that a product made from the two or more product components has sufficiently homogeneous properties after the filling process.

Advantageously, it is provided that a mixing step is carried out between two successive product component filling steps. This enables particularly efficient and comprehensive mixing of the individual product components in the container with comparatively little effort.

The disclosure also relates to an apparatus for filling a container with a liquid or paste-like product, wherein the apparatus has a filling device for filling an interior of the container with the product, and wherein the apparatus is designed such that the container and a mixing device can be can be displaced relative to each other in this way such that a mixing element of the mixing device projects into the interior of the container and the mixing element of the mixing device is displaced in the interior of the container. As with the filling methods described above, numerous apparatus are known in practice with which a container can be filled with a product. The container is positioned relative to a filling device in such a way that a quantity of product discharged from a filling nozzle, for example, is introduced into the interior of the container. The container can then be closed with an associated container lid. If the product filled into the container is to be mixed with the container lid before it is closed, a mixing element of a mixing device can be brought into the interior of the container and displaced therein in order to mix the product in the container. The mixing element is then removed from the container and the mixed container is closed with the container lid.

The use of a mixing device or a mixing element for mixing a plurality of successively filled containers can be achieved cost-effectively and automatically if a large number of similar containers are to be filled with the same product in each case. However, if successive filling processes for different products are to be carried out with the same mixing device, it is regularly necessary for the mixing device to be cleaned between two successive mixing processes in order to prevent residual quantities adhering to the mixing device from contaminating a subsequently mixed container with a residual quantity of a product from a previous mixing process of another container.

It is therefore regarded as a further object of the present disclosure to design an apparatus for filling a container with liquid or paste-like products in such a way that a mixing process required when filling the container can be carried out as efficiently as possible and with low losses of the product to be filled in each case.

This object is achieved in that the mixing device has a mixing element which, after the container has been filled, remains in the interior of the container which is then closed with a container lid. In particular, when filling the container with valuable products or with small quantities of product, this can prevent product residues adhering to the mixing element from being removed from the container after a mixing process and being lost when the container is filled. The mixing element can be designed in such a way that, after the container has been closed with the container lid, it does not impair the subsequent removal of a product quantity and can remain permanently in the interior of the container. Preferably, the mixing element is made of a material that is inert to the product filled into the container. The mixing element can occupy a comparatively small volume and only slightly reduce the interior space of the container that can be used for filling with the product.

The mixing element can, for example, have a predetermined breaking point so that the mixing element can be released from the mixing device along the predetermined breaking point after the product filled into the container has been mixed and can remain in the interior of the container after the container has been removed from the mixing device. It is also possible that the mixing element has magnetic properties and is displaced within the container by a suitable change in a magnetic field generated from outside the container and rotates, for example, about an axis of rotation determined by the magnetic field.

Such an apparatus is advantageously suitable for filling a container with several different product components. It is therefore provided according to an advantageous embodiment that the filling device has a plurality of product component storage containers, from each of which a product component can be filled into the container. The plurality of product component storage containers can be arranged in a storage container magazine, for example. To fill a container, individually specified quantities of the respective product component can be filled into the container from individually selected product component storage containers. For successively filled containers, an individual selection of the individual product components and the respective quantities of the product components can be made for each container. With a filling device of this type, successive filling processes with very individual specifications can be largely or even completely automated.

It can be provided that the filling device can be moved relative to a container position specified for the filling process, so that for each individual filling step the relevant product component storage container is brought close to the container to be filled and only a short distance between the product component storage container and the container needs to be bridged for the product component filling step. It is also conceivable and advantageous for many areas of application that the product component storage container is arranged in a fixed position during a filling process and that the container to be filled is successively approached to the respective product component storage container with a suitable container handling device in such a way that a predetermined quantity of the product component can be filled into the container from the respective product component storage container with as little loss as possible.

According to a particularly advantageous embodiment, it is provided that a product mixing device of the apparatus has a container lid handling device, with which a container lid with a mixing device with a mixing element arranged on the container lid can be gripped and moved towards the container in such a way that the mixing element of the mixing device projects into the interior of the container, and wherein the mixing element can be displaced with the container lid handling device within the interior of the container. In a particularly advantageous case, the container lid has a metering dispenser device and a mixing device, as already described above. In order to mix the product filled into the container, the container lid can be moved towards the container with the container lid handling device in such a way that the mixing element of the mixing device protrudes into the interior of the container and mixes the product in the interior of the container by moving the container lid, without the container lid already being fixed to the container as a result. In many cases, efficient mixing of the product can be achieved by a rotational movement of the container lid and the resulting rotational movement of the mixing element projecting into the interior of the container.

Since the container lid handling device can also be used to operate the mixing device, there is no need to manufacture and operate a further handling device for a separate mixing device in the apparatus designed according to the disclosure. In addition, the filling process, including individual mixing steps and the subsequent closing of the container with the container lid, can be carried out within a very short time, since, for example, after completion of the last mixing step, which was carried out with the container lid handling device, the already gripped container lid only has to be fixed to the container without the mixing device having to be removed from the interior of the container and removed from the container opening beforehand. If the container lid is fixed to the container opening by screwing it onto a correspondingly designed screw thread, for example, the container lid handling device must already be designed and configured to allow the container lid to rotate. The same rotary movement can be used to mix the product in the container during a mixing step with a container lid that is still at a distance from the screw thread in the vicinity of the container. As a result, the container lid handling device does not need to have any additional degrees of freedom or separate actuators or drive units in order to carry out both a mixing step and the subsequent fixing of the container lid to the container.

According to an alternative embodiment, it can be provided that the apparatus has a container handling device, with which the container can be gripped and moved towards a container lid with a mixing device with a mixing element arranged on the container lid in such a way that the mixing element of the mixing device projects into the interior of the container. Only relative movements between the container and the container lid are required to carry out a mixing step and then close the container opening with the container lid. For this reason, instead of a complex movement of the container lid, it can be advantageous to carry out part of the required movement sequence or the complete movement sequence with a displacement of the container, which is carried out with a suitably designed container handling device. In particular, if the apparatus is designed with a filling device that has a plurality of product component storage containers and the container to be filled is displaced to the product component storage containers that are immovably positioned in the apparatus during the filling process, it may be expedient to design the container handling device in such a way that all the movements required for the filling process can be carried out, as well as some or all of the movements required for the mixing step and for the subsequent fixing of the container lid onto the container.

With a view to optimising individual travel paths and movement sequences, it can also be advantageous for both the container handling device and the container lid handling device to take over and simultaneously perform some of the required movement sequences during a mixing step and when the container lid is subsequently secured to the container.

Consequently, an embodiment is to be provided in that the container can be displaced with the container handling device in such a way that the mixing element is displaced within the interior of the container. In this way, the mixing step can also be carried out largely or completely by suitable control and manipulation of the container handling device.

According to a particularly advantageous embodiment, it is provided that the container lid is displaced relative to the container by means of a container lid handling device in such a way that the mixing element is displaced within the interior of the container. The container lid can either be moved back and forth along a linear trajectory or rotated about a predetermined axis of rotation. Complex trajectories or displacement sequences are also conceivable in order to achieve the most efficient mixing of the product in the container.

Depending on the desired way in which the container lid is to be fixed to the container, it can optionally be provided that the apparatus has a container closure device with which the container lid can be fastened on the container after the container has been filled with the product and the product has been mixed in the container. The container lid can be screwed onto a threaded section provided for this purpose on the container by means of a rotational movement. The container lid can also be fixed to the container by latching over the container opening. It is also conceivable that the container lid is connected to the container with a material bond, wherein the container lid is connected to the container by ultrasonic welding or friction welding, for example. It is also conceivable that the container lid is glued to the container. The container locking device is used to carry out the steps required to fasten or fix the container lid to the container.

Advantageously, it can optionally be provided that the apparatus has a container magazine for holding a number of containers and a container lid magazine for holding a number of container lids, each with a mixing device arranged on the container lid. In this way, a number of containers can be filled one after the other with an individually specified product made up of different product components without the need for manual intervention or refilling of containers or container lids. Such an apparatus can be used over a long period of time to successively fill a container with a product individually prepared from various product components according to customer requirements and to dispense the container in question. Such an apparatus is suitable, for example, for the individual preparation and filling of cosmetics into containers from which a predetermined amount of product can be dispensed using a metering dispenser device until the container is completely empty. Since a separate mixing device is used for each container or for each individual product composition, the individual containers can be filled in a particularly hygienic manner. In addition, the individual filling and mixing processes can be carried out with a particularly low loss of individual product components, so that particularly efficient and cost-saving filling and subsequent mixing of the individual product components is possible, in particular for small product component quantities and valuable product components.

In the following, exemplary embodiments of the invention are explained in more detail, which are shown in the drawing by way of example.

### BRIEF DESCRIPTION OF THE DRAWINGS

FIG. 1 shows a schematic representation of the essential components of an apparatus for filling a container with a liquid or paste-like product,

FIG. 2 to FIG. 10 each show a representation of the apparatus during a method sequence for filling and mixing a container with a product composed of a plurality of product components,

FIG. 11 shows a sectional view of a container with a container lid closing a container opening of the container, which has a metering dispenser device and a mixing device,

FIG. 12 shows a sectional view of the container according to FIG. 11, wherein an actuating element of the metering dispenser device is actuated and a mixing element of the mixing device is displaced thereby, and

FIGS. 13 to 15 each show different states of the metering dispenser device and the mixing device during an actuation of the metering dispenser device to dispense a quantity of product from a container.

### DETAILED DESCRIPTION

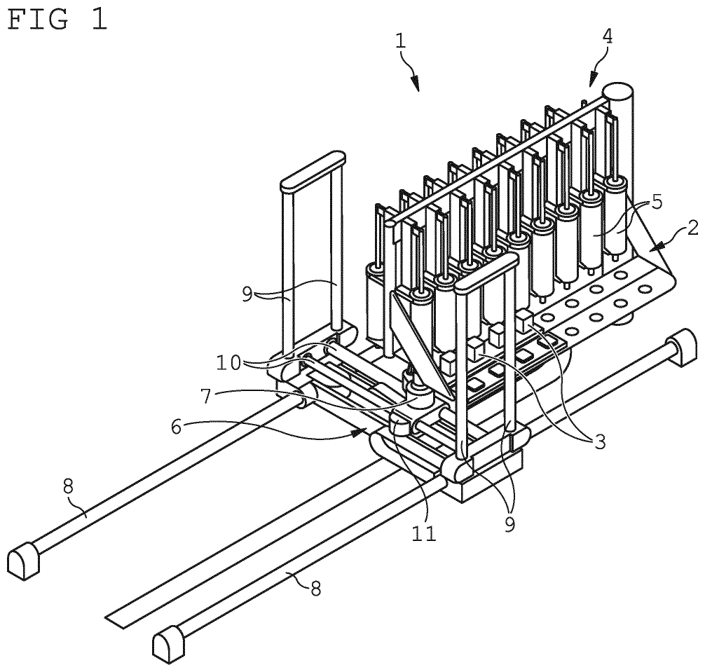

An exemplary apparatus 1 shown in FIG. 1 for filling a container (not visible in FIG. 1) with a liquid or paste-like product has a container magazine 2 with a number of containers and associated container lids 3, which are arranged in the container magazine 2 and are held for filling with the product. The apparatus 1 also has a storage container magazine 4 with a number of product component storage containers 5, in each of which a product component is kept in stock, which can be filled into a container provided for this purpose as part of a product composed of several product components.

The apparatus 1 has a container handling device 6 with which a container can be gripped and displaced in all three spatial directions within a housing of the apparatus 1 (not shown in FIG. 1). For this purpose, the container handling device 6 has a gripping and holding device 7, which can be displaced along correspondingly arranged displacement rails 8, 9, 10 on a container handling slide 11 in all three spatial directions within the housing of the apparatus 1.

A number of container lids 3 are stored in the container magazine 2. Firstly, an associated container is connected to each container lid 3. In order to fill the container, the container can be gripped by the container handling device 6 and released from the container lid 3 in order to then be filled with the product and, after a mixing process, reconnected to the container lid 3 and closed by the container lid 3.

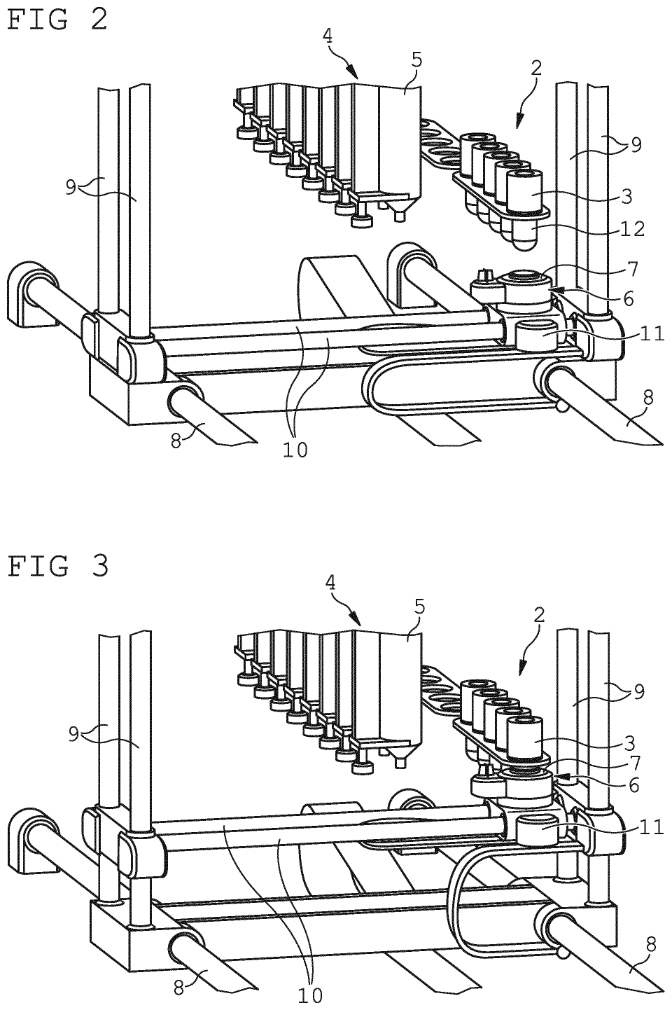

In the following, FIGS. 2 to 10 illustrate in detail various points in time during a filling process of a container with the apparatus 1 described above.

At the start of a filling process, the gripping and holding device 7 of the container handling device 6 is moved in a horizontal plane under a container 12, which is held in the container magazine 2 together with the associated container lid 3 (FIG. 2).

The container 12 is then gripped and released from the associated container lid 3 by the gripping and holding device 7, which is then displaced in a vertical direction (FIG. 3).

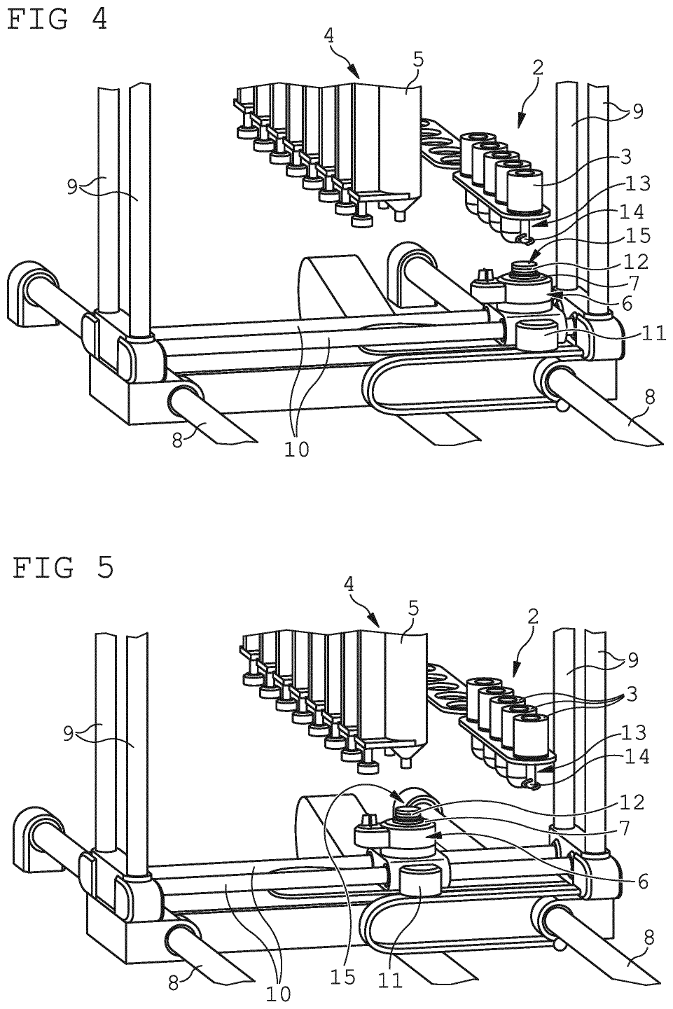

The container 12 is removed from the container lid 3 using the gripping and holding device 7, wherein a mixing device 13 arranged on the container lid 3 with a mixing element 14 is pulled out of an interior 15 of the container 12 (FIG. 4).

The container 12 is then moved with the gripping and holding device 7 of the container handling device 6 out of the container magazine 2 towards the storage container magazine 4 with the product component storage containers 5 arranged there (FIG. 5).

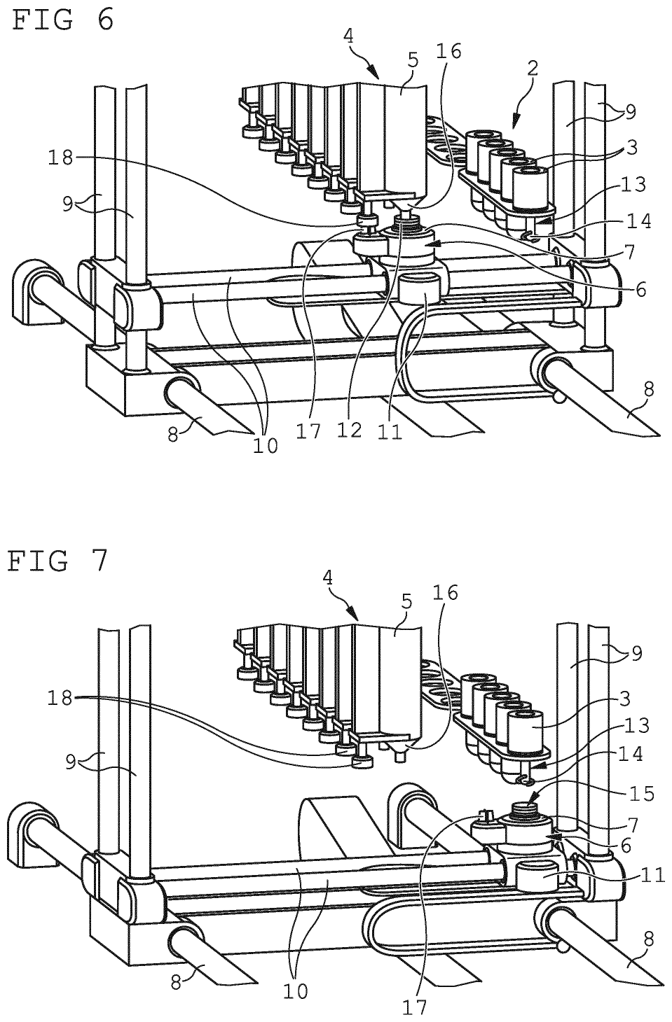

In order to fill the container 12 with a product component from a selected product component storage container 5 in a product component filling step, the container 12 is displaced directly under a product component storage container 5 and brought from below to a filling nozzle 16 of the relevant product component storage container 5. At the same time, a filling activation device 17 of the container handling device 6 deflects a filling valve actuating element 18 of the product component storage container 5, thereby opening a filling valve of the product component storage container 5 and filling a predetermined quantity of a product component from the product component storage container 5 through the filling nozzle 16 of the product component storage container 5 into the container 12 (FIG. 6).

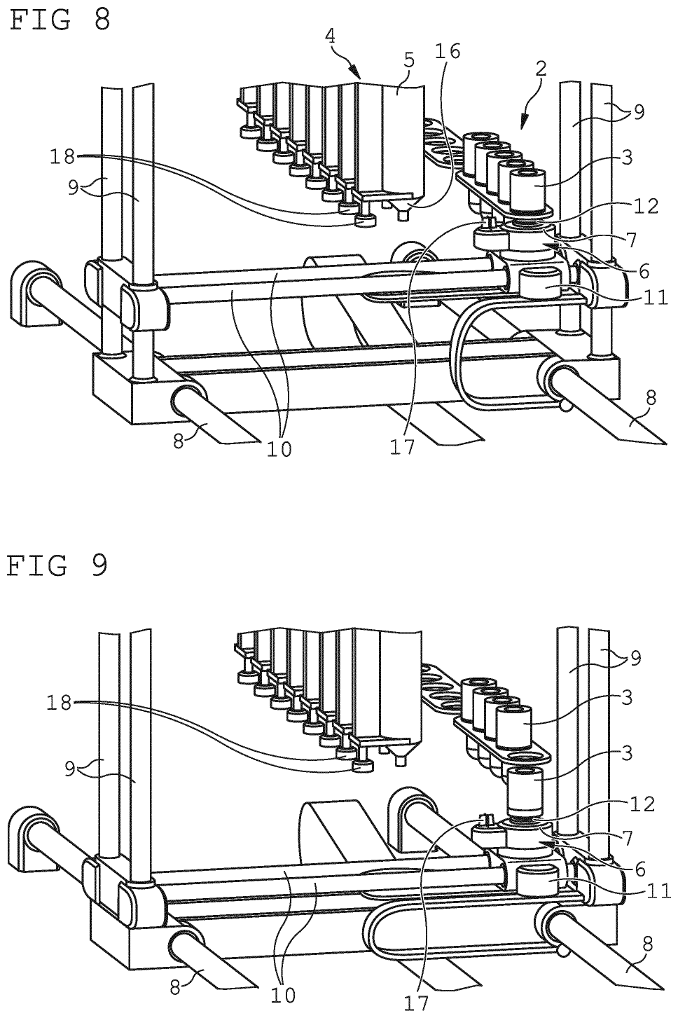

Subsequently, the container 12 is displaced away from the product component storage container 5 (FIG. 7) and back towards the associated container lid 3 using the gripping and holding device 7 of the container handling device 6, wherein the container 12 is moved and displaced in the vicinity of the container lid 3 such that the mixing device 13 with the mixing element 14 is inserted into the interior 15 of the container 12 (FIG. 8). The container 12 is then displaced back and forth several times in a vertical direction by the gripping and holding device 7 of the container handling device 6, or pivoted about a vertical axis of rotation or rotated in a rotational movement, so that the mixing device 13 projecting into the interior 15 of the container 12 mixes the quantity of product components located in the interior 15 of the container 12 with the mixing element 14.

The container 12 is then moved several times to a respective predetermined product component storage container 5 and filled with a predetermined product component quantity from the relevant product component storage container 5 and then mixed with the mixing device 13 arranged on the associated container lid 3 until the container 12 is filled with all selected product components and the product composed and mixed therefrom is produced and completely filled into the container 12.

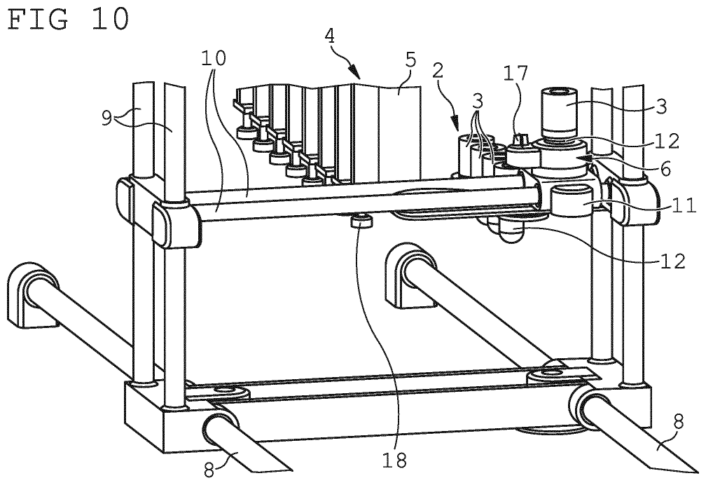

The container 12 is then brought up to the associated container lid 3 one last time and, if necessary, after another mixing step with the mixing device 13, the container lid 3 is firmly connected to the container 12, for example by screwing the container lid 3 onto a threaded section of the container 12 shown in the preceding figures. The container lid 3 is removed from the container magazine 11 (FIG. 9).

Finally, the completely filled and thoroughly mixed container 12, which is closed with the container lid 3, is moved in a vertical direction with the gripping and holding device 7 of the container handling device 6 to a dispensing opening in the housing (also not shown) and held ready for dispensing from the apparatus 1 (FIG. 10).

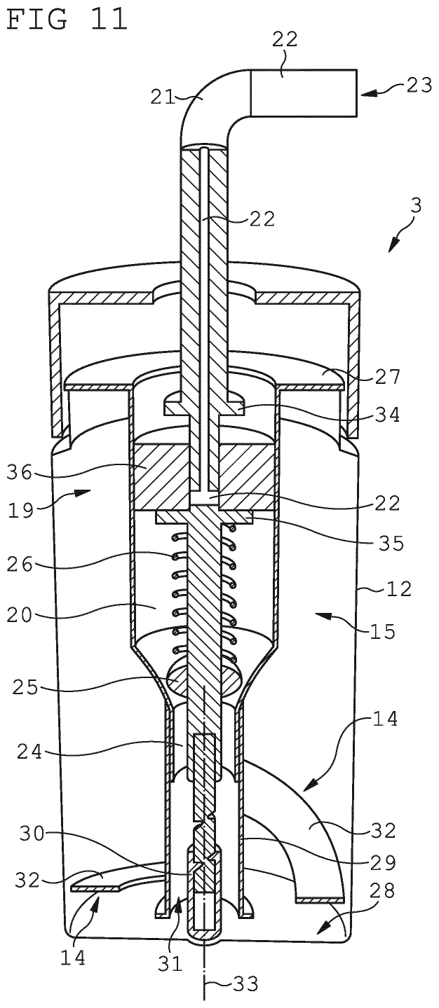

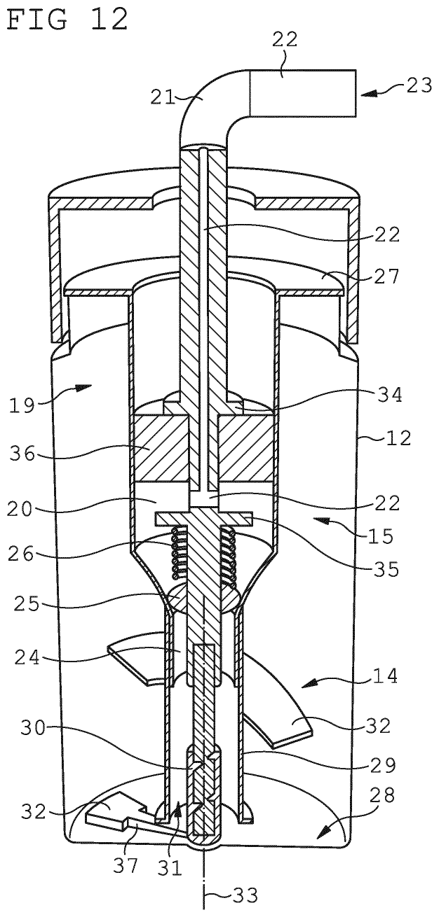

FIGS. 11 and 12 each show an exemplary and schematic representation of a container 12 with the container lid 3 fixed on the container 12. The container lid 3 has a metering dispenser device 19 with a metering dispenser chamber 20, an actuating element 21 and a product dispensing channel 22 extending in the actuating element 21, which opens into a product dispensing opening 23 in the actuating element 21. At its end opposite the product dispensing opening 23, the product dispensing channel 22 opens into the metering dispenser chamber 20. A chamber opening 24 of the metering dispenser chamber 20 can be closed or opened by a closing element 25. When the actuating element 21 is actuated and displaced in the direction of the metering dispenser chamber 20, the chamber opening 24 of the metering dispenser chamber 20 is closed with the closing element 25 and a predetermined quantity of product is conveyed from the metering dispenser chamber 20 through the product dispensing channel 22 and dispensed from the product dispensing opening 23 (FIG. 12). As soon as the actuating element 21 is released, it is displaced back into an initial position by a spring device 26, thereby simultaneously refilling the metering dispenser chamber 20 with a quantity of product that flows from the interior 15 of the container 12 through the chamber opening 24 into the metering dispenser chamber 20 (FIG. 11). A piston element 36, which is movably mounted between two stops 34, 35, is displaced away from an orifice of the product dispensing channel 22 opening into the metering dispenser chamber 20 when the actuating element 21 is actuated and releases the orifice of the product dispensing channel 22, so that with increasing penetration of the piston element 36 into the metering dispenser chamber 20 a quantity of product is pressed out of the metering dispenser chamber 20 through the released orifice into the product dispensing channel 22 and a corresponding quantity of product is dispensed from the product dispensing opening 23 (FIG. 12). As soon as the actuating element 21 is released and is displaced further out of the interior 14 of the container 12 again due to the spring force of the spring device 26, the opening of the product dispensing channel 22 is first closed again by the piston element 36 and then the piston element 36 is pulled out of the metering dispenser chamber 20 again, so that a quantity of product corresponding to the quantity of product previously pressed into the product dispensing channel 22 flows from the interior 14 of the container 12 into the metering dispenser chamber 20 and fills it up again (FIG. 11).

In extension of the chamber opening 24 of the metering dispenser chamber 20, an intake tube 29 is formed extending away from a lid body 27 and extending to a bottom 28 of the container 12. The actuating element 21 of the metering dispenser device 19 is in engagement with a mixing element sleeve 30. At an end of the mixing element sleeve 30 facing the base 28 of the container 12, a suction opening 31 is formed between the mixing element sleeve 30 and the surrounding intake tube 29, through which the product located in the interior 15 of the container 12 is sucked in near the bottom 28 and drawn into the metering dispenser chamber 20. Two mixing elements 14, each extending helically and over half a circumference, are fixed to the rotatably mounted mixing element sleeve 30, which is operatively connected to the actuating element 21, via connecting webs 37, and have a mixing blade 32 projecting into the interior 15 of the container 12 at a radial distance from the mixing element sleeve 30. When the actuating element 21 is actuated, the actuating element 21 is pressed in an axial direction into the interior 15 of the container 12. Via the active connection, the mixing element sleeve 30 and the mixing elements 14 fixed thereto with the helically extending mixing blades 32 are set in a rotational movement and rotated about a displacement axis 33 running through the centre of the interior 15 of the container 12. As a result, the product, which is composed of a plurality of product components, is mixed in the interior 15 of the container 12 immediately before it is sucked into the metering dispenser chamber 20 through the intake opening 31 by the backward displacement of the actuating element 21. In this way, it is possible to ensure that a well-mixed quantity of product is sucked into the metering dispenser chamber 20 and dispensed through the product dispensing opening 23 when the actuating element 21 is subsequently actuated.

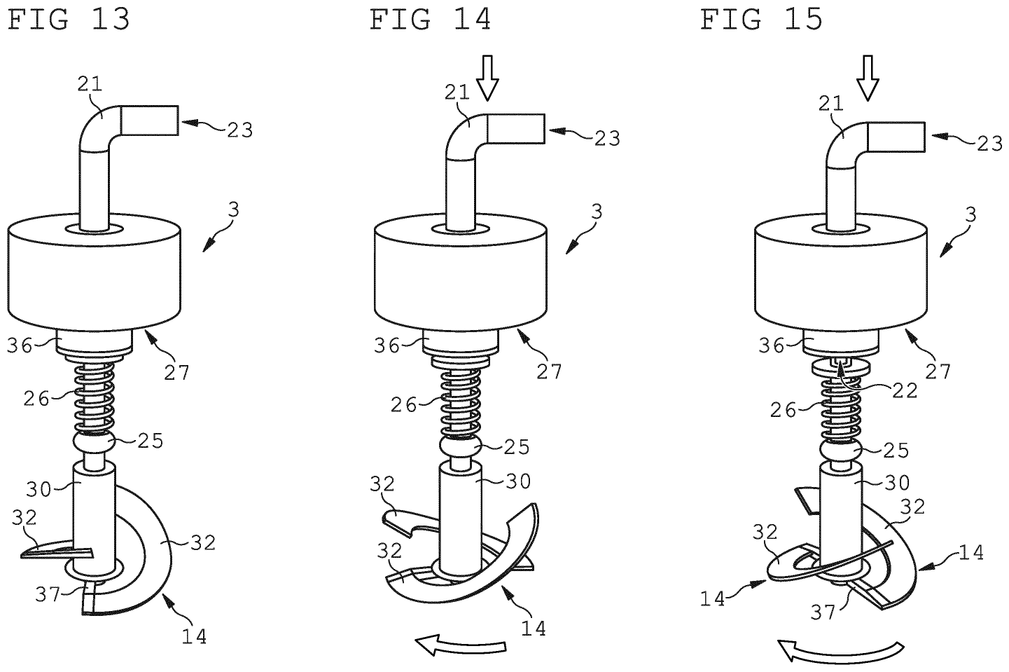

FIGS. 13 to 15 each show only the container lid 3 with the metering dispenser device 19 arranged thereon and with the mixing device 13. FIGS. 13 to 15 thus show by way of example that as the actuating element 21 is increasingly displaced, the mixing element sleeve 30 is rotated and the mixing elements 14 fixed to the mixing element sleeve 30 and correspondingly carried are also rotated as a result, causing mixing of the product in the interior 15 of the surrounding container 12 (not shown in FIGS. 13 to 15).

1.-22. (canceled)

23. A container lid (3) for a container (12) for holding a liquid or paste-like product, comprising:
a lid body (27), which can be fixed to a container housing of the container (3) via a container opening, and
a manually operable metering dispenser device (19), by which a predefinable quantity of the product can be dispensed from the container housing through a product dispensing opening (23) of the metering dispenser device (19) when an actuating element (21) of the metering dispenser device (19) is actuated,
wherein, when the container lid (3) is used as intended with the container (12), the container lid (3) engages with a mixing device (13) for the product located in the container (12),
wherein the mixing device (13) has a displaceable mixing element (14), which is operatively connected to the actuating element (21) of the metering dispenser device (19) and which is displaced by an actuation of the actuating element (21).

24. The container lid (3) according to claim 23,
wherein the mixing device (13) is arranged on the container lid (3).

25. The container lid (3) according to claim 23,
wherein the metering dispenser device (19) has an intake pipe (29) extending away from the lid body (27) for the product to be dispensed through the product dispensing opening (23), and
wherein the mixing element (14) is displaceably mounted on an end region of the intake pipe (29) remote from the lid body (27).

26. The container lid (3) according to claim 25,
wherein the mixing element (14) extends in a longitudinal direction of the intake pipe (29) beyond an intake opening (31) formed in the intake pipe (29) for the product to be dispensed.

27. The container lid (3) according to claim 25,
wherein the mixing device (13) has a displaceably mounted mixing element sleeve (30), which is arranged coaxially to the intake pipe (29) and is operatively connected to the actuating element (21), so that the mixing element sleeve (30) is displaced relative to the intake pipe (29) when the actuating element (21) is actuated.

28. The container lid (3) according to claim 23,
wherein the mixing element (14) is pivotably mounted about a displacement axis (33) extending away from the lid body (27).

29. The container lid (3) according to claim 23,
wherein the mixing element (14) has at least one mixing blade (32) extending along a helical line.

30. The container lid (3) according to claim 29,
wherein the at least one mixing blade (32) is mounted at a radial distance with respect to a displacement axis (33).

31. A method for filling a container (12) with a liquid or paste-like product, comprising:
filling the product into the container (12) through a container opening in a filling step with a filling device;
closing the filled container (12) with a container lid (3);
mixing the product filled into the container (12) in a mixing step;
bringing the container lid (3) into operative connection with a mixing device (13) in an interior (15) of the container (12) or
introducing a mixing device (13) with a mixing element (14) that is part of the container lid (3) into an interior (15) of the container (12); and
displacing a mixing element (14) of the mixing device in the interior (15) of the container (12) before the container lid (3) is fixed on the container (12) and the container opening is thereby closed.

32. The method according to claim 31,
wherein, in the mixing step, the container lid (3) is used with a metering dispenser device (19), with which a predefinable quantity of the product can be dispensed from the container through a product dispensing opening (23) of the metering dispenser device (19) when an actuating element (21) of the metering dispenser device (19) is actuated and is used with the mixing device (13).

33. The method according to claim 31, further comprising
removing the filled container (12) with the container lid (3) closing the container opening from the filling device.

34. The method according to claim 31, further comprising
rotating the container lid (3) about an axis of rotation in the mixing step with the mixing device (13) projecting into the interior (15) of the container (12), without the container lid (3) thereby being fixed on the container (12).

35. The method according to claim 31,
wherein, in the filling step, at least two product component filling steps are carried out one after another, in which one product component is filled into the container (12) at a time, and
wherein the mixing step is carried out between two successive product component filling steps.

36. An apparatus (1) for filling a container (12) with a liquid or paste-like product, comprising:
a filling device for filling an interior of the container (12) with the product,
wherein the apparatus (1) is designed such that the container (12) and a mixing device (13) can be displaced relative to each other such that a mixing element (14) of the mixing device (13) projects into the interior (15) of the container (12) and the mixing element (14) of the mixing device (13) is displaced in the interior (15) of the container (12),
wherein the mixing element (14), after filling the container (12), remains in the interior (15) of the container (12), and
wherein the container (12) is closed with a container lid (3) when the container (12) is removed from the apparatus (1).

37. The apparatus (1) according to claim 36,
wherein the filling device has a plurality of product component storage containers (5), from each of which a product component can be filled into the container (12).

38. The apparatus (1) according to claim 36,
wherein a product mixing device of the apparatus has a container lid handling device, with which the container lid (3) with the mixing device (13) with the mixing element (14) arranged on the container lid (3) can be gripped and moved towards the container (12) in such a way that the mixing element (14) of the mixing device (13) projects into the interior (15) of the container (12), and
wherein the mixing element (14) can be displaced with the container lid handling device within the interior (15) of the container (12).

39. The apparatus (1) according to claim 36,
wherein the apparatus (1) has a container handling device (6), with which the container (12) can be gripped and moved towards the container lid (3) with the mixing device (13) with the mixing element (14) arranged on the container lid (3) in such a way that the mixing element (14) of the mixing device (13) projects into the interior (15) of the container (12).

40. The apparatus (1) according to claim 39,
wherein the container (12) can be displaced with the container handling device (6) such that the mixing element (14) is displaced within the interior (15) of the container (12).

41. The apparatus (1) according to claim 38,
wherein the container lid (3) can be displaced relative to the container (12) by the container lid handling device in such a way that the mixing element (14) is displaced within the interior (15) of the container (12).

42. The apparatus (1) according to claim 36,
wherein the apparatus (1) has a container closure device with which the container lid (3) can be fastened on the container (12) after the container (12) has been filled with the product and the product has been mixed in the container (12).

43. The apparatus (1) according to claim 36,
wherein the apparatus (1) has a container magazine (2) for holding a plurality of containers (12) and a container lid magazine for holding a plurality of container lids (3), each with a respective mixing device (13) arranged on the container lid (3).
